(19) United States
(12) Patent Application Publication
(10) Pub. No.: US 2014/0040064 A1
(43) Pub. Date: Feb. 6, 2014

(54) Method of Selling Golf Bags and Golf Bag Kits

(71) Applicant: Doug Anderson, Maidens, VA (US)

(72) Inventor: Doug Anderson, Maidens, VA (US)

(73) Assignee: DYNAMIC BRANDS, LLC, Richmond, VA (US)

(21) Appl. No.: 13/564,263

(22) Filed: Aug. 1, 2012

(51) Int. Cl. G06Q 30/06

(52) U.S. Cl. CPC G06Q 30/0621
USPC 705/26.5

(57) ABSTRACT

Methods of selling golf bags and golf bag kits are described that include selling components of a golf bag that have been selected from a golf bag kit of interchangeable components. The components of the golf bag kit of interchangeable components may include, but are not limited to, golf bag shells or golf bag shell sub-assemblies, top members or top member sub-assemblies, bottom members or bottom member sub-assemblies, strap systems, stand system components, and accessories, for example. Individual components may be selected from a plurality of interchangeable components of each category to produce a customized golf bag. The components may then be aggregated and assembled to form a golf bag.

### FIELD OF THE INVENTION

The invention relates to methods for selling golf bags, golf bag kits, and golf bag components. Embodiments of a method of selling golf bags and golf bag kits comprise selling components of a golf bag that have been selected from a golf bag kit of interchangeable components. The components of the golf bag kit of interchangeable components may include, but are not limited to, golf bag shells or golf bag shell sub-assemblies, top members or top member sub-assemblies, bottom members or bottom member sub-assemblies, strap systems, stand system components, and accessories, for example. Individual components may be selected from a plurality of interchangeable components of each category to produce a customized golf bag. The components may then be aggregated and assembled to form a golf bag.

### BACKGROUND

Golf is a popular game that requires a significant amount of equipment to play including balls, a set of clubs, shoes, tees and a golf bag to organize and protect the equipment. Golf bags are available in many styles and types of bags. Generally, there are at least four different types of golf bags including, but not limited to, cart bags, stand or carry bags, staff or tour bags and travel bags. Cart bags are designed to be used when golfing with a golf cart. The cart bags may be placed in the back of the golf cart and not carried by the golfer. Therefore, cart bags are generally larger and heavier than their stand bag equivalents. Since cart bags are not designed to be carried for the entire length of the golf course, cart bags are generally heavier and comprise a shell with many more features than carry bags. A cart bag shell may have more pockets and larger compartments for balls, accessories, apparel, umbrellas, towels, keys, coins, etc. Additionally, the top member of a cart bag may have more partitioning dividers forming a rigid, grid-like structure for keeping each club separate and organized within the bag. The bottom member of a cart bag may have a larger footprint than a stand or carry bag.

Stand or carry bags are designed to be carried with a golfer as they walk the golf course playing a round of golf. Therefore, stand bags are generally lighter and have less accessories than cart bags. The stand golf bags may comprise a shell or top member having a retractable stand system such as tripod-like stand. The stand system allows the golf bag to stand upright without being held by the golfer or the bags without stands may merely be laid on the course. Stand or carry golf bags may be made of lightweight materials, and smaller components such as, but not limited to, top members and bottom members. Some features available on cart bags are sacrificed in carry bags in the interests of comfort and weight.

Carry bags vary from simple sleeve-like bags having a couple of pockets, a top member with only a few partitioning dividers and no stand system to full-feature bags with a variety of compartments on the golf bag shell, a top member with more partitioning dividers and an automatic stand system, for example. Carry bags will further comprise a better carrying strap than a cart bag, usually a single or double strap that may be padded for comfort.

Tour bags are used by golfers on the professional tours and comprise a golf bag shell having a distinctive design, brand-related colors and the manufacturer's brand name prominently placed on the bag. Tour bags are another form of carry bag.

Travel golf bags are designed to protect golf clubs during travel, by airline, car, or other means. There is a variety of types of travel golf bags comprising golf bags with soft shells, hard shells, top members with detachable hard or soft covers. Multipurpose travel bags may be used to protect your clubs while traveling and can also be used as carry, stand or cart bags when playing on the golf course.

There are a wide variety of top members, bottom members and golf bag shells required to produce all the different types of golf bags. Each type of golf bag will have several varieties of top members, bottom members, and golf bag shells to satisfy the consumer's requirements. Many of the components of each type of golf bag are not interchangeable, further many of the components of different styles of the same type of golf bags are not interchangeable. Each style of bag is individually designed with a specific combination of components. Therefore, consumers are limited by the combinations of top members, bottom members and golf bag shells that are provided by the golf bag manufacturers. Further, each type of golf bag is also specifically designed for women and men.

Completed golf bags are bulky and expensive to ship and store for manufacturers, distributors, and retail stores. The storage of a sufficient inventory of golf bags is difficult due to the number of varieties, styles, accessories and colors of golf bags desired by golfers.

There exists a need for a method of selling a golf bag comprising receiving a selection of available golf bag components from a golf bag kit. The golf bag components may be stored and shipped independently to be assembled by a third party such as, but not limited to a retail store or consumer. The consumer may choose from a plurality of interchangeable components to design a type and style of golf bag that includes the features that they desire. There is an even further need for a golf bag kit that may be shipped for less cost, individual components selected by the consumer, and a golf bag with the desired features assembled from the selected individual components by a distributor, retail store or by the consumer.

There is also a need for a new method of buying a golf bag and a method of designing a golf bag from a golf bag kit.

### SUMMARY

The invention relates to a method of selling golf bags, golf bag kits, and golf bag components allowing a certain degree of customization of the golf bag for the consumer. An embodiment of the method of selling a golf bag, golf bag kit, or components of a golf bag comprises providing a selection of various interchangeable components that may be assembled into a golf bag. The interchangeable components may include golf bag shells or golf bag shell sub-assemblies, top members or top member sub-assemblies, bottom members or bottom member sub-assemblies, strap systems, stand system components, and accessories, for example. The accessories may include, but are not limited to, umbrella holders, towel hooks, tee holders, marker holders, ball holders, for example. For example, an embodiment of the method comprises providing a selection from a plurality of golf bag shell sub-assemblies and a plurality of bottom members. Each of the bottom members in the plurality of golf bag bottom members may be selectively connected to any of the golf bag shell and/or golf bag shell sub-assemblies. The consumer, retail store or distributor (“consumer”) may select any of the golf bag shells and bottom members to create a golf bag kit. The golf bag kit may be assembled to provide a customized golf bag from the available choices.

In some embodiments, the golf bag kit may be assembled by the consumer, the retail store or the distributor. The selections of the consumer may be received by any means, for example, the selections of the consumer may be received through an Internet web site, over a computer network, at a retail store, by telephone, or through a catalog.

In another embodiment, the method of selling a golf bag comprises providing a selection from a plurality of golf bag shell sub-assemblies, a plurality of bottom members and/or a plurality of top members, wherein each of the bottom members and each of the top members are capable of selectively being connected to the golf bag shell. A selection of components is received from the consumer of each component of the golf bag kit to be assembled into the golf bag. Each of the components may be individually priced such that the consumer may select the components that include the features that they desire for the cost that they would like to spend.

After selection of the components, the selected top member and/or bottom member are capable of being permanently connected to the golf bag shell or golf bag shell sub-assembly. In a typical embodiment, the components may be assembled without use of specialized tools such as sewing machines and rivet guns. In some embodiments, the components may be assembled with the use of typical household tools such as, but not limited to, screw drivers, pliers and wrenches, for example.

A further embodiment of a method of selling a golf bag comprises receiving a selection of a selected golf bag shell, receiving selection of a selected golf bag bottom member from the plurality of bottom members that are capable of being permanently connected to the selected golf bag shell, and receiving a selection of a selected golf bag top member from the plurality of top members that are capable of being permanently connected to the selected golf bag shell.

Any of the top members, bottom members or golf bag shells may be a component of a sub-assembly that may be selected by the consumer as a component of the golf bag kit.

In another embodiment, the method may comprise instructing a consumer to assemble the golf bag from the selected golf bag components.

In a still further embodiment, a method of selling a golf bag comprises providing a choice from at least one golf bag shell sub-assembly having an open bottom end, wherein the open bottom end is defined by a bottom end collar and the bottom end collar comprises a bottom connector; providing a choice from plurality of bottom ends, wherein each bottom end comprises a complementary connector capable of connecting the bottom end to the bottom connector. The selected golf bag shell and the selected bottom end may then be sold as a golf bag kit with instructions to assemble the selected bottom end to the open bottom end to provide a golf bag.

An embodiment of the method comprising selling an unassembled golf bag kit comprises a golf bag shell, a bottom member capable of being permanently connected to one end of the golf bag shell and a top member capable of being permanently connected to the other end of the golf bag shell. The golf bag kit may be shipped for less cost than a completed golf bag. The golf bag kit comprises connectors on the golf bag shell and complementary connectors on the top member and the bottom member such that the top member and bottom member may be connected to the shell without special tools.

In another embodiment, the golf bag kit comprises at least one golf bag shell and a plurality of other golf bag components that may be selectively connected to the golf bag shell to form a golf bag. The golf bag components may include top members, bottom members, stand systems, pockets, as well as other accessories, for example. The golf bag kit may comprise a plurality of interchangeable golf bag shells.

In certain embodiments, the compatible connectors are manual connectors that may be connected without the use of specialized tools, such as without the use of a sewing machine or rivet gun, for example. In some embodiments, the connectors may be attached to each other without the use of any tools. The connectors may be slot and pin connectors, for example.

Embodiments of a method of selling golf bags and golf bag kits may comprise selecting from a top member or a golf bag top member covering as a component of a golf bag or a golf bag kit as described in the patent application by the same inventor entitled as described in a “Golf Bags, Golf Bag Top Members, and Golf Bag Top Member Coverings” and/or allowing a selection of components of a golf bag kit as described in a patent application by the same inventor entitled “Golf Bag Kits,” for example, both applications incorporated herein by reference in their entirety. The method may further comprise selecting a top member covering from a selection of interchangeable covering materials.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of components, parts, techniques and steps are disclosed. Each of these has individual benefit and each can also be used in conjunction with one or more, or in some cases, all of the other disclosed embodiments and techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### BRIEF DESCRIPTION OF THE DRAWINGS

FIG. 1 depicts a typical carry golf bag comprising a golf bag shell, a top member, a bottom member and a stand system;

FIG. 2 is a flow sheet depicting steps in an embodiment of a method of selling a golf bag or a golf bag kit;

FIG. 3A and FIG. 3B depicts two golf bag shell sub-assemblies of a golf bag kit that may be selected by a consumer;

FIG. 4A, FIG. 4B and FIG. 4C depicts three top members of a golf bag kit that may be selected by a consumer, the top members may be part of a top member sub-assembly;

FIG. 5A, FIG. 5B and FIG. 5C depicts three bottom members of a golf bag kit that may be selected by a consumer, the bottom members may be part of a bottom member sub-assembly;

FIG. 6 depicts a golf bag shell sub-assembly comprising an enclosure, a top collar, a bottom collar and stays connected to the top collar and bottom collar;

FIG. 6A depicts an embodiment of a tab and slot connector such as a tab and slot connector for permanently connecting a bottom member to a bottom collar;

FIG. 7 depicts embodiments of a bottom member, a bottom collar and an intermediate member;

FIG. 8 depicts another embodiment of bottom member and bottom collar comprising a connector to connect a bottom member to a bottom collar of a golf bag shell;

FIG. 9 depicts another embodiment of a bottom member;

FIG. 10 depicts an embodiment of a top member comprising partitioning dividers that form seven golf club receiving apertures at three different elevations;

FIG. 11 depicts another embodiment of a top member comprising partitioning dividers that form six golf club receiving apertures;

FIG. 11A depicts embodiments of a top member and a golf bag shell sub-assembly with complementary profiles;

FIG. 11B depicts a cross-sectional view of an inner wall and an outer wall of an embodiment of the top member of FIG. 11;

FIG. 12 depicts an embodiment of a top member sub-assembly comprising a top member, partitioning straps, and an intermediate member; and

FIG. 13 depicts the embodiments of the bottom member, bottom collar and intermediate member of FIG. 7 connected together to form the bottom end of the golf bag.

### DESCRIPTION

Golf is a popular game that requires a significant amount of equipment to play including, but not limited to, a set of golf clubs, balls, shoes, tees and a golf bag to carry, organize and protect the equipment from damage. A set of golf clubs, typically, consists of twelve clubs including three woods (the 1-driver, 3 wood, and 5 wood), at least 1 hybrid, seven irons (4, 5, 6, 7, 8, 9, and PW), and a putter. However, the rules of golf allow a golfer to carry up to fourteen clubs in a golf bag, so many golfers add another wedge or specialty hybrid. Golfers carry specially designed golf bags to organize and protect their clubs during use, storage and travel. Golf bags are available in many styles and types. The golf bags may also comprise pockets for storing golf balls, golf tees, shoes, towels, beverages and other items such as wallets, keys, phones, etc.

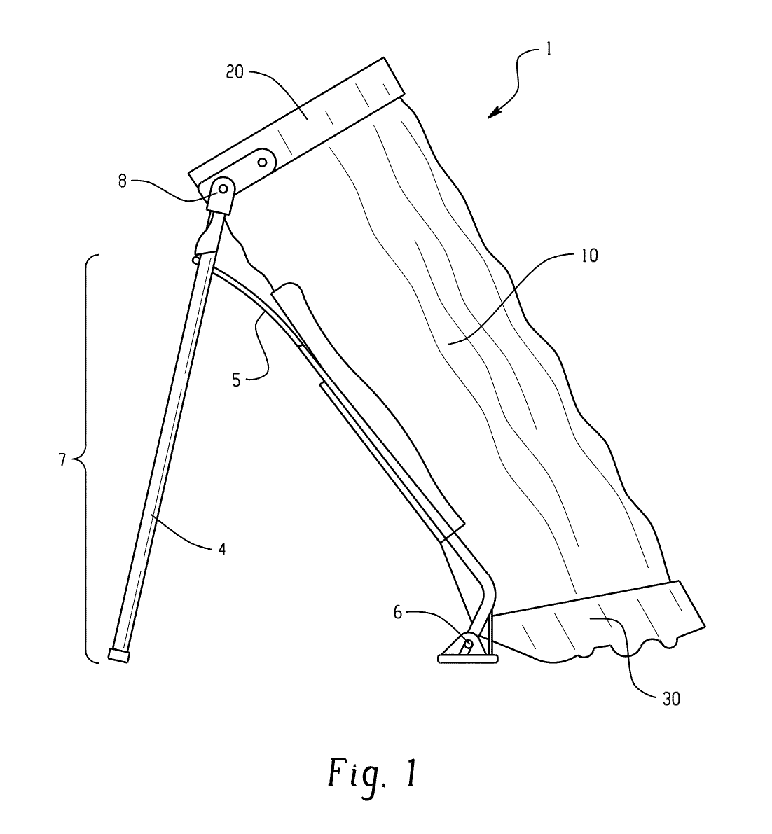

An embodiment of a typical stand bag is shown in FIG. 1. The golf bag 1 comprises golf bag shell 10 forming an enclosure, a top member 20 comprising partitioning dividers for organizing the golf clubs, and bottom member 30 to protect the enclosure from wear. The golf bag 1 may further comprise a stand system 7 including legs 4, a pivot member 5 and a foot 6. The stand system provides two additional legs to hold the bag upright without being held.

Golf bags are manufactured as completed golf bags in designs anticipated by the manufacturer to be commercially desirable to the golfer in the upcoming golf season. A wide variety of golf bags are manufactured by attaching a specifically designed golf bag bottom and a specifically designed golf bag top member to the golf bag shell. Conventionally, golf bag bottom members and top members are typically sewn onto the golf bag enclosures at the manufacturing site and then shipped to the distributors and retail stores for storage and sale. The consumer may then choose a complete golf bag from the variety of manufactured designs available from a sporting goods retail store, online retail store, or catalog. The selections of golf bags available to the consumer at a retail store depend on the storage capacity of the retail store on their sales floor and/or their storage room.

However, a golfer may not desire the combination of features of any of the available golf bags. For example, a golfer may desire the features of a more expensive cart bag shell with a less expensive or lighter bottom member and a top member with fourteen apertures for receiving golf clubs or may want to match the colors of the bag to their favorite sports team, for example. The consumer then must chooses a bag from the current inventory with the best overall compromise of features and style that is available in the price range that the consumer would like to spend for a golf bag. The consumer does not have the ability to design a golf bag that meets their particular desires but must select from what is available at the time. Embodiments of the method of selling a golf bag or a golf bag kit comprise manufacturing a golf bag kit comprising a plurality of unassembled interchangeable components. As used herein, “interchangeable components” means that each of the components in the kit may be selectively attached at the appropriate location of the golf bag. For example, in one embodiment each of the golf bag bottom members may be permanently connected to a bottom collar of a golf bag shell sub-assembly. However, the term interchangeable does not necessarily mean that one bottom member may easily be removed from the golf bag shell sub-assembly and replaced with another bottom member. The term “interchangeable” means that any of the similar components of the golf bag kit may be connected to the appropriate location. Thus, each of the top members and/or the bottom members of the golf bag kit may be permanently connected to the golf bag shell. Thus, a consumer may choose a desired golf bag shell from the selection of interchangeable golf bag shells and/or golf bag sub-assemblies, a desired top member and/or top member sub-assemblies from the selection of interchangeable top members, and a desired bottom member from the selection of interchangeable bottom members from the components in the golf bag kit for assembly into a golf bag.

The golf bag kit may provide the consumer with choices from a plurality of various interchangeable components including but not limited to, golf bag shells or golf bag shell sub-assemblies, top members or top member sub-assemblies, bottom members or bottom member sub-assemblies, strap systems, stand system components, and accessories, for example. The accessories may include, but are not limited to, umbrella holders, towel hooks, tee holders, marker holders, ball holders, for example. In one embodiment of a golf bag kit only one interchangeable component is available, for example, a golf bag may be complete except for a top member. The top member may be selected from a variety of interchangeable top members.

The selected components are then provided for assembly by the seller or to the consumer for assembly. In one embodiment, the retailer comprises a selection of interchangeable components on their sales floor or on a computer screen. The consumer selects one of each available component to customized their golf bag for purchase. The golf bag is then assembled by the retailer and sold to the consumer as a completed golf bag. In such embodiment, the golf bag kit may comprise a plurality of interchangeable golf bag shell sub-assemblies, top member sub-assemblies, strap systems, stand systems and/or bottom members, for example.

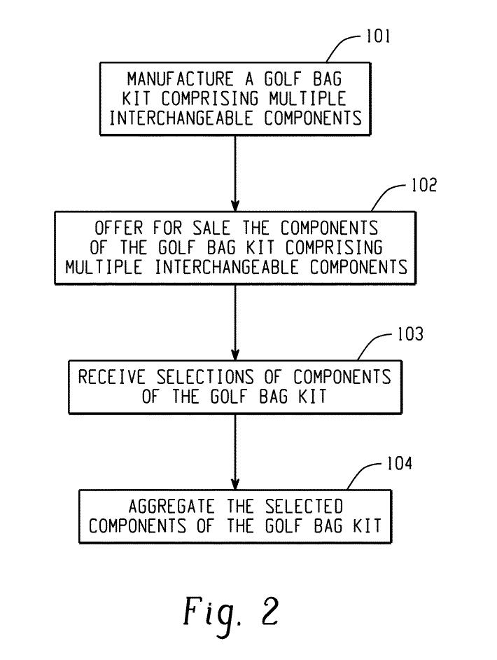

An embodiment of the method for selling a golf bag is shown in FIG. 2. In the embodiment of FIG. 2, the method comprises step 101 manufacturing or having manufactured a golf bag kit comprising interchangeable golf bag components. The interchangeable golf bag components may comprise sub-assemblies, wherein the sub assembly is manufactured as individual parts of the sub-assembly then assembled to form the completed sub-assembly. The components of the golf bag kit may be manufactured and/or assembled by one or more manufacturers.

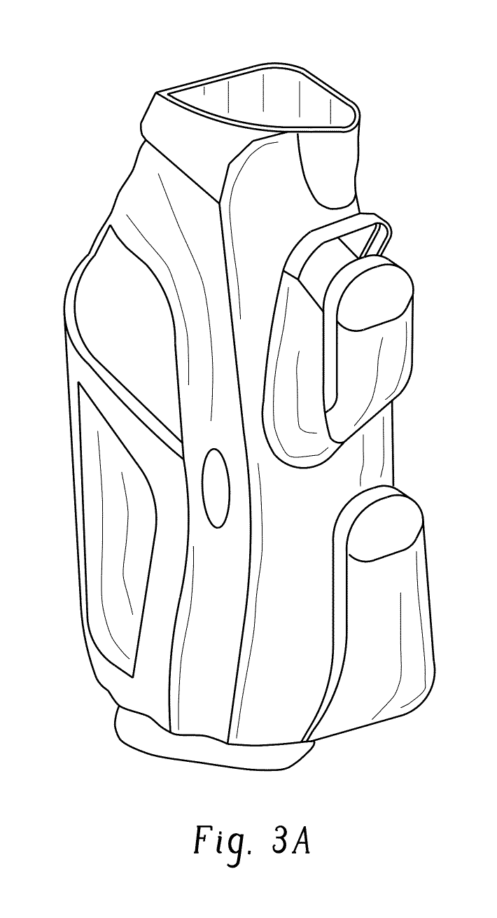

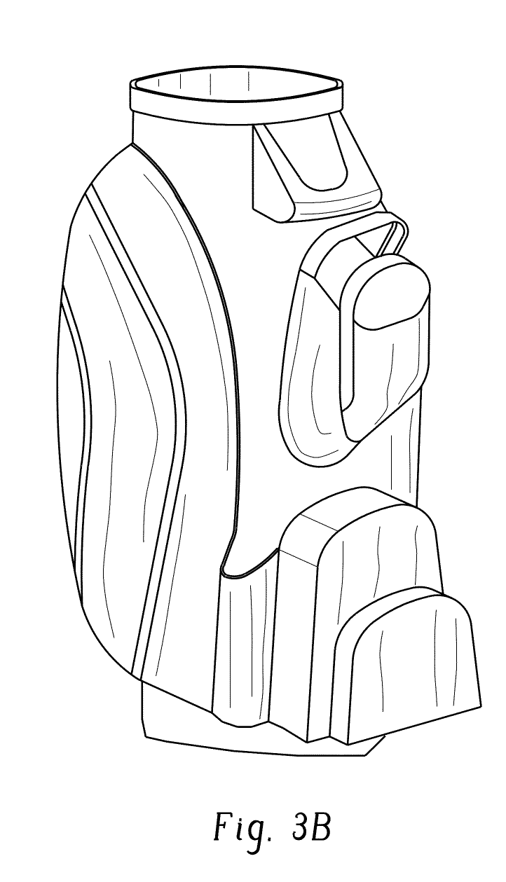

In certain embodiments, the components of the golf bag kits are not assembled to form a complete golf bag and may be shipped to the consumer as a collection of components to be assembled into the complete golf bag. The interchangeable components of an embodiment of a golf bag kit are depicted in FIGS. 3A, 3B, 4A, 4B, 4C, 5A, 5B, and 5C for a cart golf bag. Additional embodiments of the golf bag kit may comprise more or less components than depicted in these figures. The components shown may additionally be available in multiple colors or materials of construction. As Components of embodiments of golf bag kits are described in patent application entitled “Golf Bag Kits” filed on the same date and by the same inventor, which is hereby incorporated by reference in its entirety.

FIG. 3A and FIG. 3B depicts two golf bag shell sub-assemblies of a golf bag kit that may be selected by a consumer. The golf bag shell sub-assembly of FIG. 3A comprises an enclosure made of durable nylon material, eight pockets including an insulated cooler pocket, lift handles, and an external putter tube, a top collar, a bottom collar and four internal stays. The golf bag shell sub-assembly of FIG. 3B comprises nine pockets including a fleece lined valuables pocket with an internal key clip and a removable insulated cooler pocket, two external putter tubes with secure putter clips, quick access neoprene ball sleeve, deluxe carabiner towel clip, and a hook and loop glove holder. Additional golf bag shells may comprise more or less pockets or other features.

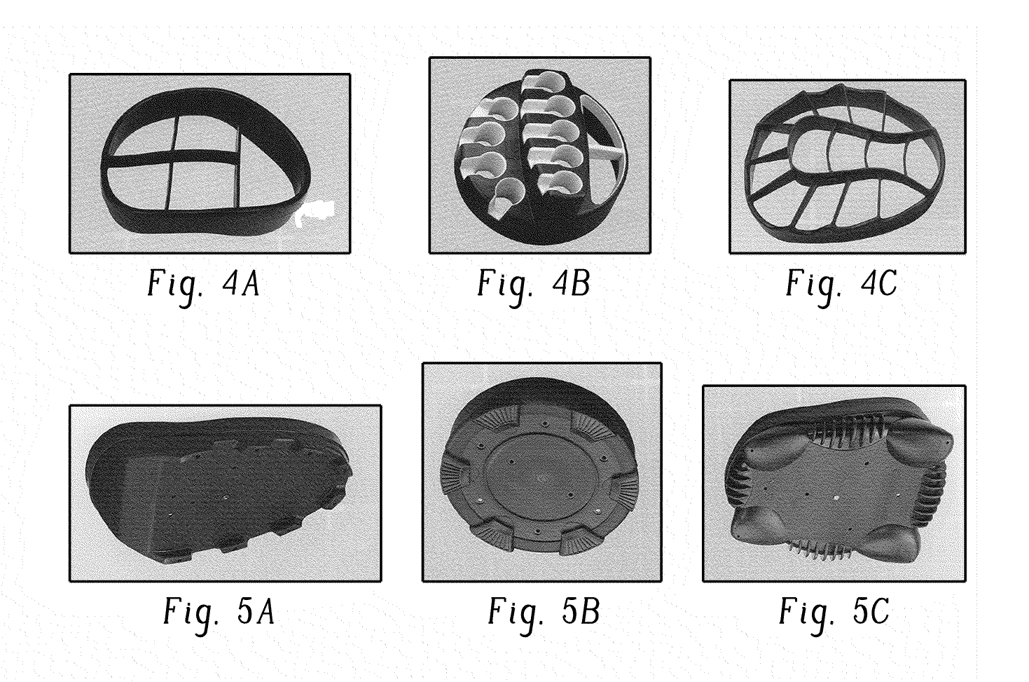

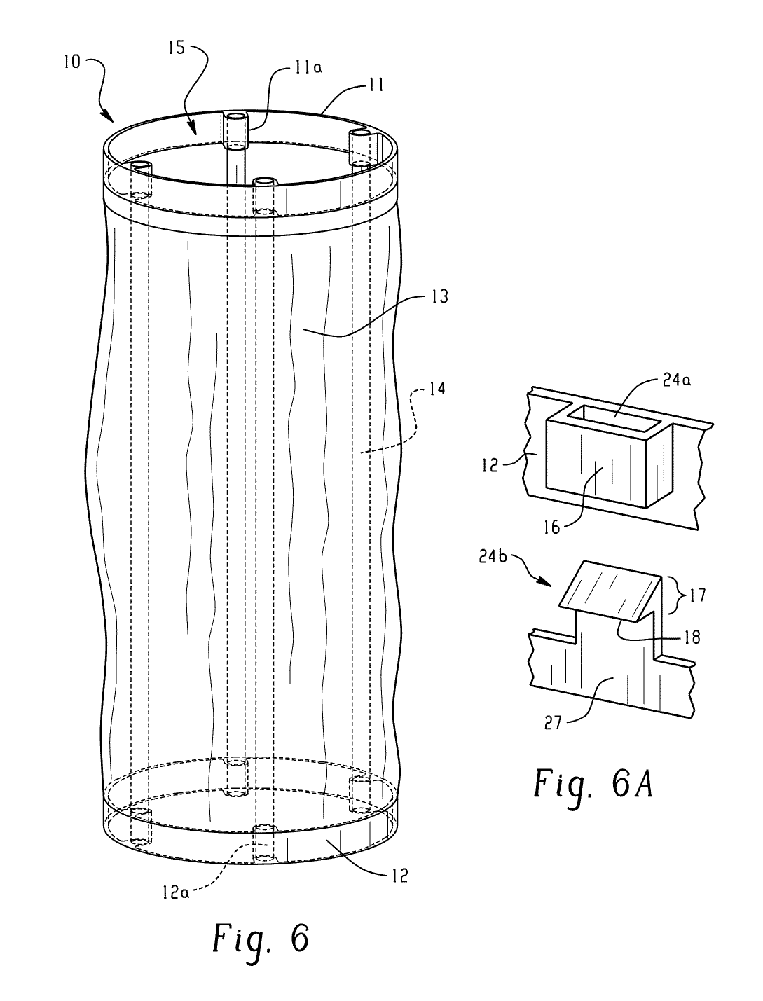

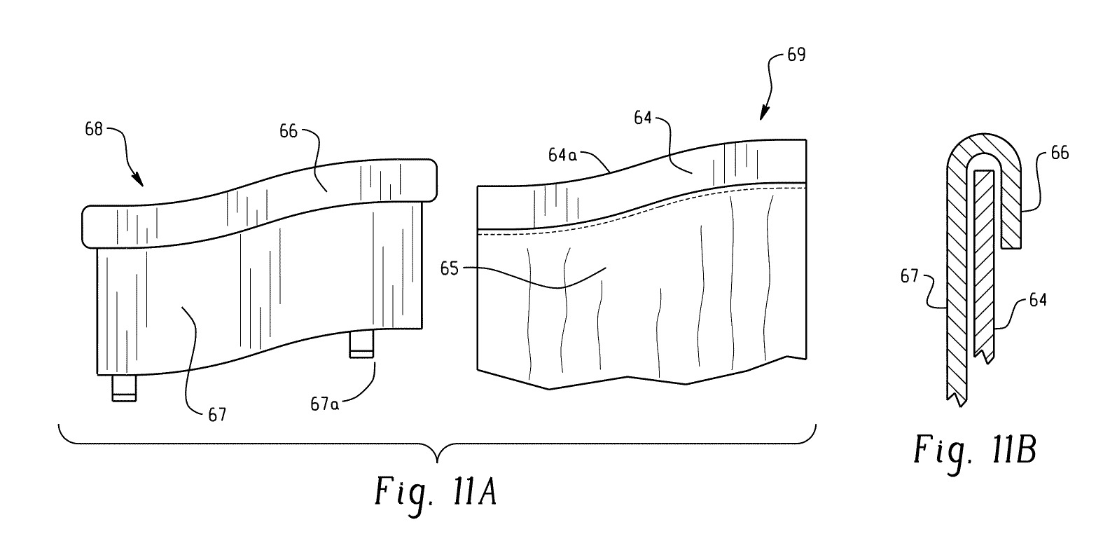

FIG. 4A, FIG. 4B and FIG. 4C depicts three top members of a golf bag kit, one of which a consumer may select for assembly into a golf bag; the top members may be part of a top member sub-assembly. In addition to the top members, the top member sub-assemblies may comprise partitioning straps, an intermediate member and a cover over the top member section dividers, for example. The top member depicted in FIG. 4A comprises partitioning dividers providing five apertures for organizing the golf clubs. FIG. 4B comprises nine individual circular apertures having associated slots to stabilize the heads of the irons and putter and two additional apertures for woods, for example. A top member sub-assembly comprising the top member of FIG. 4B may comprise partitioning straps defining an individual divider system for each of the circular slots, for example, while the partitioning straps of a top member sub-assembly comprising the top member of FIG. 4A may only comprise two divider straps, for example. The top member depicted in FIG. 4C comprises partitioning dividers providing fourteen individual apertures for organizing the golf clubs. Though the top members of FIGS. 4A, 4B and 4C have different peripheral shapes, the flexible top collars of the golf bag shell sub-assemblies may deform to conform to the shape of the more rigid top member peripheral side walls. In some embodiments, the top members further comprise substantially similar vertical profiles so that the top collar 64 of the golf bag shell sub-assembly may slip into a lip defined by an inner wall 67 and an outer wall 66 of the top portion of the top member as shown in FIG. 11B. Each of the top members or top member sub-assemblies and the top collar comprise compatible connectors that are equally spaced to allow permanent connection of the top member to the top collar of the golf bag shell sub-assembly such as, but not limited to the connectors shown in FIG. 6A.

The top collar may have a top profile. In certain embodiments, the top profile of the top collar is substantially similar to the top profile of the top member. Top members and top collars are further described in patent application entitled “Golf Bag Top Member” filed on the same date and by the same inventor, which is hereby incorporated by reference in its entirety.

FIG. 5A, FIG. 5B and FIG. 5C depicts three bottom members of a golf bag kit that may be selected by a consumer. The bottom member may be part of a bottom member sub-assembly. The bottom member of FIG. 5A comprises an elongated foot print with multiple protrusions and an angular portion that may be used in conjunction with a stand system to provide a hybrid golf bag. The bottom member of FIG. 5B is a round bottom member that comprises six molded feet. The bottom member of FIG. 5C has a generally rectangular shape and four large molded feet to provide additional stability while the bag is standing up. The bottom members of FIGS. 5A, 5B and 5C have different peripheral shapes but have substantially similar outer perimeter lengths on their top portion that may be inserted into the bottom collar of the golf bag shell sub-assemblies shown in FIGS. 3A and 3B during assembly of the golf bag. Though the bottom members of FIGS. 5A, 5B and 5C have different peripheral shapes, the flexible bottom collars may deform to conform to the shape of the more rigid bottom member peripheral side walls. Further, the bottom members and the bottom collar comprise compatible connectors that are equally spaced to allow permanent connection of the bottom member to the bottom collar of the golf bag shell sub-assembly.

An additional step 102 shown in the embodiment of the method of selling golf bags shown in FIG. 2, offering for sale components of a golf bag kit or multiple golf bag kits comprising multiple interchangeable components. Each golf bag kit may comprise interchangeable components. The seller may offer a selection of interchangeable components from each component. The seller may offer a selection of each interchangeable component from a four component stand bag kit, for example. The consumer may select a golf bag shell from a selection of four golf bag shell sub-assemblies. Each of the interchangeable golf bag shell sub-assemblies available in the kit may have a top collar comprising a substantially similar inner perimeter length and a similar top profile. The top collars of the golf bag shell sub-assemblies are capable of connecting to each of the top member sub-assemblies available for selection in the golf bag kit. In one embodiment, the top members have connectors complementary to the connectors on the top collars, in other embodiments, separate connectors such as pins, screws, bolts or adhesives may be used. In this way, the consumer may select any of the golf bag shells in the golf bag kit and any of the top member sub-assemblies and the components will be capable of being connected together. Similarly, the bottom collars of the golf bag shells may be connected to any of the bottom members in the golf bag kit.

Step 103 of the embodiment of the method shown in FIG. 2 comprises receiving selections of the components from a consumer. The consumer selects one component from each set of components that are available in multiple styles and/or configurations in the golf bag kit. For example, the consumer may select the top member of FIG. 4A because it is light weight, the golf bag shell depicted in 3B for the added pockets, the removable cooler pocket and two external putter sleeves, and the round bottom member of FIG. 5B. The consumer may select the components and the selections may be received through an internet web site, over a computer network, at a retail store, by telephone, or through a catalog.

Step 104 comprises aggregating the selected components for shipment and/or assembly. The components may be directly assembled, shipped to a retail store or distributor for assembly or shipped to the consumer for assembly, for example. The golf bag may be assembled from the aggregated components.

In one embodiment, the top member sub-assembly is assembled into golf bag shell sub assembly. The top member sub-assembly comprises a top member, an intermediate member and partitioning straps connected between the top member and the intermediate member. The top member sub-assembly may further comprise a flexible covering material. The intermediate member is inserted through the golf bag shell and connected to the bottom collar of the golf bag shell. The bottom member may be connected to the golf bag shell by inserting the pin connectors of the intermediate member into the slots of the bottom collar, for example. Other connection types may also be used. A portion of the top member may then be fitted to the top collar and, in some embodiments; the top collar may be inserted into a lip or recess of the peripheral structure of the top member. The top member is then connected to the top collar by inserting the pins into slots in the top collar. The bottom member may be connected to the bottom collar in a similar manner.

The golf bag kit and method of selling golf bags, golf bag kits, and golf bag components provide the consumer flexibility in designing a desired golf bag from various unassembled interchangeable components. The components of the kit are capable of being connected together to form the desired golf bag. For example, an embodiment of the method of forming a golf bag kit comprises receiving a selection of a golf bag shell or a golf bag shell sub-assembly from the plurality of golf bag shells or golf bag shell sub-assemblies, receiving a selection of a bottom member from a plurality of bottom members comprising bottom connectors capable of permanently connecting the bottom member to the golf bag shell, and receiving a selection of a top member comprising top connectors capable of permanently connecting the top member to the golf bag shell. The selections may be received from a consumer, retail store or distributor, for example. The method may further comprise aggregating the selected components. The aggregated components may be assembled by the seller, retailer, or distributor or may be shipped to the consumer as separate components for assembly to reduce shipping and manufacturing costs.

One embodiment of the method of selling a golf bag is depicted in FIG. 2. Other methods may comprise a subset of the steps shown in FIG. 2, for example, another embodiment of the method does not comprise step 101, but includes steps 102, 103 and 104. For example, a retailer or distributor may purchase a golf bag kit or multiple golf bag kits from the manufacturer or a third party. The retailer or distributor may then receive the selections of the desired golf bag kit and the components from the consumer and aggregate the selected components for example.

As such, another embodiment includes a method of selling a golf bag kit comprises manufacturing or having manufactured a golf bag kit comprising a plurality of interchangeable components as described herein. This embodiment further comprises selling the golf bag kit.

In some embodiments, the golf bag shell sub-assembly comprises an enclosure, a top collar, a bottom collar and stays extending between the top collar and the bottom collar. The top collar and the bottom collar may be flexible. In some embodiments, the top collar and bottom collar are sufficiently flexible to allow the golf bag shell, the top collar and the bottom collar to be reduced to at least half of a dimension of either the top collar or the bottom collar. In some embodiments, the top collar and bottom collar are sufficiently flexible to allow the golf bag shell, the top collar and the bottom collar to be reduced to at least one third of a dimension of either the top collar or the bottom collar. In a portion of these embodiments, the dimension is a width or a diameter of the top collar or the bottom collar. In further such embodiments, the top collar and the bottom collar are resilient enough to return substantially to its original dimension. As used herein, a component is “resilient enough to return substantially to its original dimension” if after applying a force to reduce an original dimension to the final desired dimension and removing the force, the component returns to within 20% of its original dimension, or in specific embodiments returns to within 10% of its original dimension. In such embodiments, at least two golf bag shells may fit in a typical golf bag shipping container that could only hold one complete golf bag, thereby reducing shipping and storage costs. For example, a typical golf bag shipping container may be 15″×15″×38″ (other golf bag shipping containers may be 12″×12″×38″, for example. Therefore, the original dimension of the top collar or bottom collar would be less than 15″ and may be compress to less than 7.5″ or less than 5″ or less than 3.75″. In other embodiments, the golf bag is not resilient enough for the top collar and bottom collar to compress to less than 2″ and still be resilient enough to return substantially to its original dimension.

The golf bag kits comprise multiple golf bag components that may be selected to be assembled into a complete golf bag. For example, an embodiment of the golf bag kit comprises at least one golf bag shell sub-assembly 10 and a plurality of other golf bag components that may be selectively connected to the golf bag shell sub-assembly to form a golf bag. The golf bag components may include top members 20, bottom members 30, stand systems 7, pockets, carrying strap systems, as well as other accessories, for example. Embodiments of the method of selling a golf bag may comprise a selection of all of these components or only a portion of the components. For example, in one embodiment, the method comprises receiving a selection from at least one golf bag shell and a plurality of bottom members, wherein each of the bottom members may be selectively connected to the golf bag shell. In another embodiment, the method comprises receiving a selection from at least one golf bag shell and a plurality of top members, wherein the golf bag top members comprise different configurations and each of the top members may be selectively connected to the golf bag shell. Only one of the plurality of top members and/or one of the plurality of bottom members may be connected to the golf bag shell at any one time. Another embodiment of the method comprises receiving a selection from at least one golf bag shell, receiving a selection from a plurality of bottom members and receiving a selection from a plurality of top members. Each of the top members and bottom members are designed to independently be connected to the golf bag shell to form a golf bag.

Though there is no limit to the number of golf bag shells, bottom members, top members and/or other components in the golf bag kits, in one example, the golf bag kit may comprise from 2 to 4 configurations of golf bag shells, from 2 to 10 configurations of bottom members and from 2 to 10 configurations of top members. The golf bag bottom members and top members may vary simply by color, shape, and/or may include other differentiating features. The golf bag shell may also be differentiated by color, shape, material, and/or other features. However, each of the golf bag top members may be selectively connected to the golf bag shell by permanent complementary connectors on the golf bag shell and the golf bag top members and each of the golf bag bottom members may be selectively connected to the golf bag shell by permanent complementary connectors on the golf bag shell and the golf bag bottom members. Thus, the components of the golf bag shell are capable of being mixed and matched as desired by the golfer. The golf bag kit may further comprise a plurality of flexible covering materials. The flexible covering materials may be a synthetic or natural material, woven or woven, various thickness, include a foam or other cushioning layer, and/or different colors.

From the golf bag kit comprising a plurality of golf bag shell sub-assemblies, bottom members and top members, a selected bottom member and a selected top member may be attached to a selected golf bag shell to form the completed golf bag. The bottom member 30 and top member 20 may be installed at a manufacturing site or warehouse, at a distributor's warehouse, at the point of sale, or by the consumer. Further, the top member may be supplied as part of a top member sub-assembly. In one embodiment, the top member sub-assembly may comprise a top member, partitioning straps and an intermediate member. The top member of the top member sub-assembly may be attached to the top of the golf bag shell to form the golf club receiving aperture and the partitioning straps and intermediate member are inserted into the golf bag shell to connect the intermediate member at the bottom of the golf bag shell, for example, on the bottom collar of the golf bag shell. The intermediate member may have an alignment aid to assist in correct orientation and installation of the intermediate member with the bottom collar in the golf bag shell.

Similarly in additional embodiments, the bottom member may be sold as part of bottom member sub-assembly. For example, the bottom member subassembly may comprise a bottom member, partitioning straps, components of a stand system such as, for example, a foot activator or a wire spring, and/or an intermediate member for connecting to the top collar.

The sub-assemblies and components can be assembled into a complete golf bag by attaching a bottom member, stand system, strap system, flexible covering material and/or top member sub-assembly to the golf bag shell sub-assembly, for example. As previously described, a golf bag shell sub-assembly may comprise components including, but not limited to, the golf bag shell, a top collar, a bottom collar and/or stays. The selected bottom member 30 may be connected to the bottom collar of the golf bag shell 10 such as by a snap-fit connection, interference fit or other permanent connection and the top member 20 or a top member sub-assembly may also be connected to a top collar of the golf bag shell by a snap-fit connection, interference fit or other permanent connection. Other connection types such as screws, pins, rivets, hook and loop connections, and/or adhesives may be used to attach the components together, for example. Similarly, each of the other components may be connected together by similar means.

The top member or top member sub-assembly may be connected to the top collar of the golf bag shell. In embodiments of the golf bag kit comprising a top member sub-assembly, the intermediate member may be connected to a bottom portion of the golf bag shell such as to the bottom collar, thus extending and tightening the partition straps. The bottom member may also be connected to the bottom collar (or in some embodiments to the intermediate member) of the golf bag shell to produce a golf bag. The method of forming a golf bag may further comprise connecting other components such as, but not limited to, straps, stand systems, pockets and other accessories.

Golf Bag Shells

The golf bag kit comprises at least one golf bag shell. In other embodiments, the golf bag kit comprises a plurality of golf bag shells. Golf bag shells may vary in materials of construction of the fabrics, plastics and accessories, color, size, weight, and features. Basically, the golf bag shell defines the enclosure for storing and protecting the golf clubs and may comprise pockets, hooks, connectors for a golf bag stand system, connectors for a strap system, and other accessories. The enclosure includes an open end for receiving golf clubs and other items into the interior of the golf bag shell. The top end of the enclosure is connected to a top member that defines the golf club receiving opening and, typically but not necessarily, the top member provides partitioning dividers for organizing the golf clubs to be carried in the golf bag. The bottom end of the golf bag shell is typically connected to a bottom member to close the bottom end to retain the clubs in the golf bag and prevent wear of the enclosure during use of the golf bag.

Many golf bag shells comprise an enclosure made from a flexible fabric or other flexible material such as nylon, polyester, nylon/polyester blends, ripstop nylon, plastic, leather, synthetic leathers, woven materials such as cotton, canvas, or woven synthetics. Each of these materials is available in various weights and properties. Golf bag shells, especially golf bag shells for travel bags, may also comprise rigid materials such as, but not limited to, plastics to protect the golf clubs during travel. The golf bag shell 10 may be manufactured and assembled with other components as a golf bag shell sub-assembly. If the golf bag shell is made of a rigid plastic, the golf bag shell may comprise all the connectors and may not further comprise collars.

An embodiment of a golf bag shell sub-assembly, as shown in FIG. 6, may comprise a top collar 11, a bottom collar 12, a golf bag enclosure 13 connected to the top collar 11 and the bottom collar 12 and stays 14 installed between the top collar 11 and the bottom collar 12 to retain the shape of the golf bag shell and to connect the top member and the bottom member. The stays may be inserted into stay recesses 11a in the top collar and stay recesses 12a on the bottom collar. The top collar 11 and the bottom collar 12 may be flexible such that the sub-assembly may be radially compressed to allow packing of two or more sub-assemblies in a shipping box typically capable of holding only one complete golf bag to reduce shipping costs. The embodiment of the golf bag shell shown in FIG. 6 may comprise further additional components that have not been depicted.

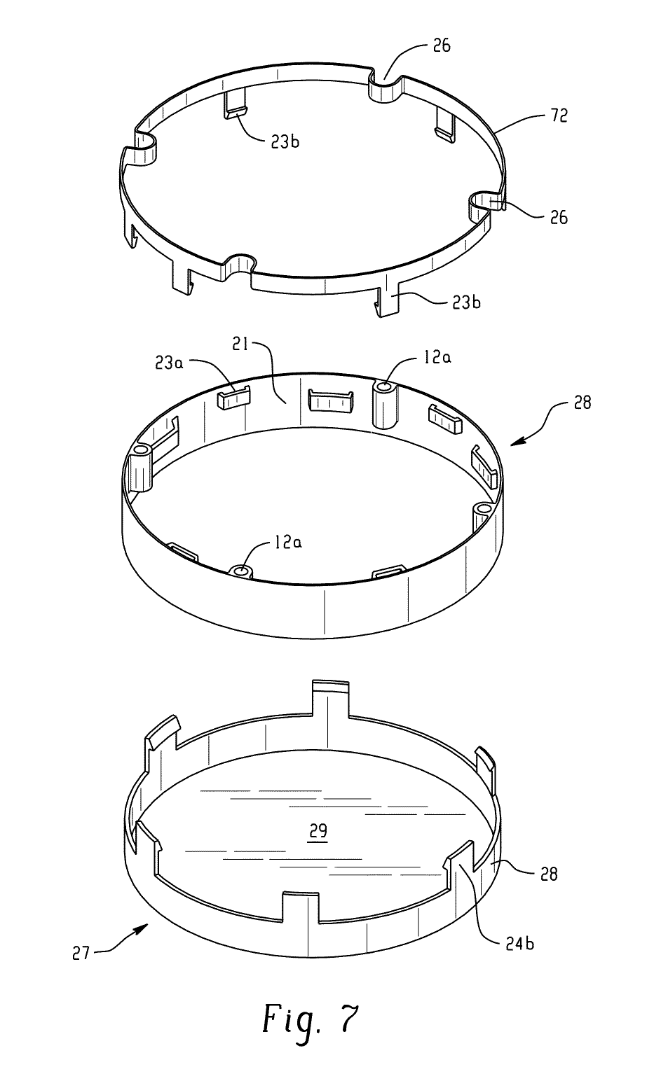

The top collar 11 and/or the bottom collar 12 may be attached to the golf bag shell adjacent to the top end and the bottom end of the golf bag enclosure 13 by any means including, but not limited to, sewing, stitching, rivets, screws, bolts, and/or adhesives, for example. In the embodiment of FIG. 6, the top collar 11 defines a golf club receiving opening 15 of the golf bag shell. The top collar and/or the bottom collar may comprise connectors capable of connecting the bottom member 30 and/or the top member 20 or top member sub-assembly to the golf club shell 10. An embodiment of the connector is shown in FIG. 6A. Embodiments of connectors may be slot and tab connectors. In the embodiments shown in FIGS. 6, 7 9, 10 and 11, the slot connectors comprise a slot 24a defined by a housing 16 on the bottom collar 12 and tabs 24b on the bottom member 27 as shown in FIG. 6A. The tabs 24b comprising a tapered top portion 17 transitioning to a lip 18. The tapered top portion 17 guides insertion of tab 24b into the slot 24a. As the tapered top portion 17 is pressed into the slot 24a, the slot 24a expands and the top tapered portion is compresses until the lip 18 protrudes through the slot 24a. The lip 18 catches on the housing 16 thus providing the permanent connection of the bottom member 27 to the bottom collar 12.

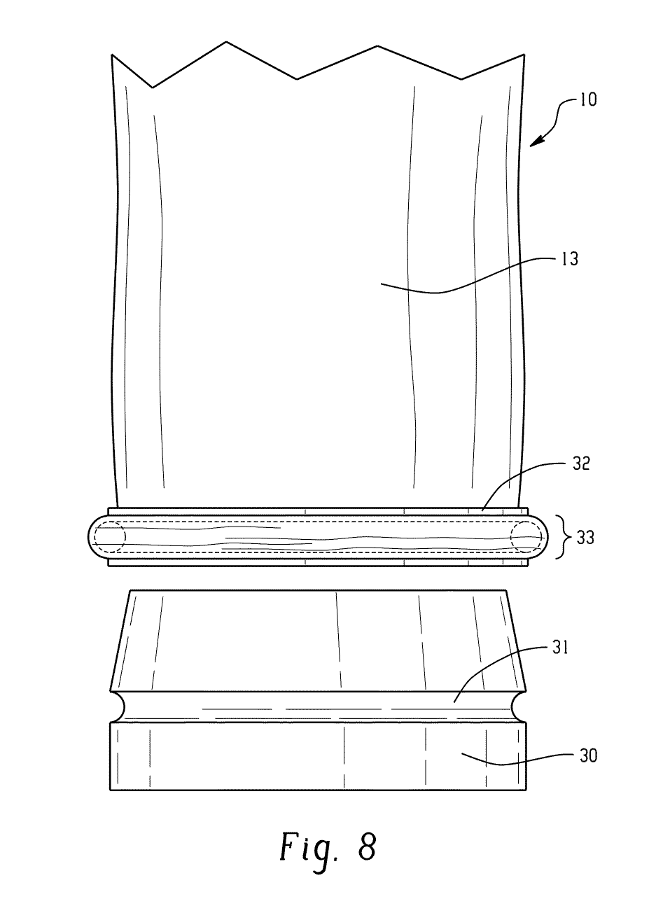

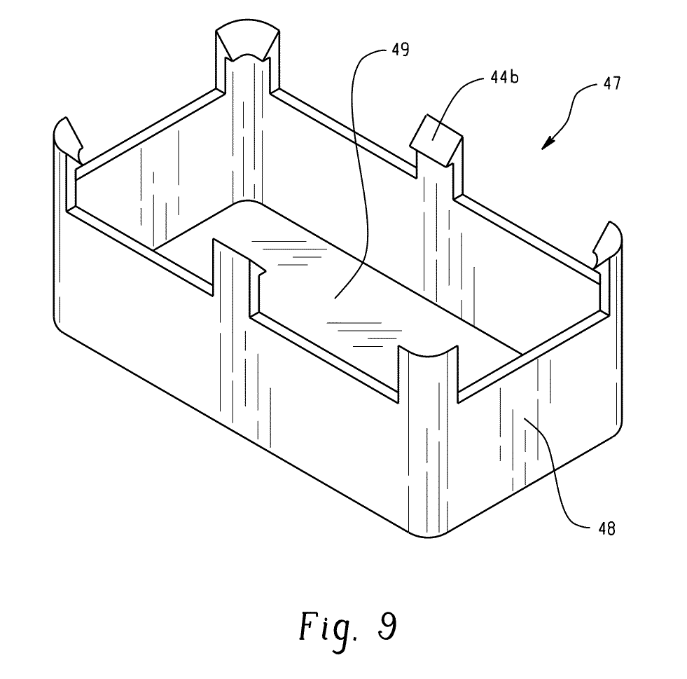

Embodiments of the collars may be any desired shape including closed shapes such as, but not limited to, a circle or oval or may open be shapes such as, but not limited to, a flexible strip or a plurality of elements that are fastened around the bottom of the golf bag shell. As such, as used herein, “collar” is used to describe any part or parts that are attached or may be attached to the golf bag shell. The collars may comprise a connector for attaching additional components to the golf bag shell such as, but not limited to, a top member, partitioning straps, intermediate member or a bottom member. The connectors may be complementary to connectors on the top members, partitioning straps, intermediate member, and bottom members for selectively attaching each component to the golf bag shell. The collar itself may be capable of providing a friction or interference fit to connect the golf bag shell to the bottom member or top member. For example as shown in FIG. 8, the collar 32 may be a wire ring attached to the golf bag shell 10 or sewn into a hem 33 of the flexible enclosure 13 golf bag shell 10 that may be forced into a groove 31 in the bottom member 30 or a similar groove in the top member (not shown) to secure the components together. In embodiments of the golf bag kit, the collar 12 may be capable of being attached to the inside or outside of the golf bag enclosure 13.

The connectors on either the top collar or the bottom collar may be any connector capable of permanently connecting the top member or the bottom member to the golf bag shell. The term “permanently”, as used herein, means the connector retains the two components connected during normal use of the golf bag during play and travel. The components may be capable of being separated with the use of sufficient force or tools, in some embodiment, the connectors will be broken to remove the components once the golf bag is assembled. Other embodiments may comprise releasable connectors that allow removing and replacing the bottom members without damage to the components. For example, the bottom member could be removed and replaced to convert a stand bag into a cart bag.

Referring again to FIG. 6, embodiments of the golf bag shell 10 may further comprise at least one stay 14 that extends over a sufficient portion of the length of the golf bag shell 10. The stays 14 may be connected to the top collar 11 and bottom collar 12 of the golf bag shell to maintain the shell in an extended position. The stays may be individual components such as the fiberglass rods shown in FIG. 6, or may be a tube of a rigid material such as plastic. In some embodiments, wherein the golf bag enclosure is a rigid enclosure, the stays may not be included in the golf bag shell.

Bottom Members

The golf bag kit may comprise a plurality of golf bag bottom members. The golf bag bottom members may be different from the other golf bag bottom members in the golf bag kit by shape, color, weight, perimeter shape, bottom pattern, footprint, stand system capabilities, wheels, or other features. The desired features of the bottom member may be based on the type of golf bag or may be based solely upon preferences of the golfer. Each of the golf bag bottom members provided in the golf bag kit may selectively be attached to a bottom portion of the golf bag shell 10 to produce the desired golf bag. Therefore, in some embodiments, each of the golf bag bottom members comprises at least one connector capable of being attached to any of the golf bag shells available in the golf bag kit. In other embodiments, the bottom member may not comprise a connector but may be attached to the golf bag shell by a separate connector such as, but not limited to, stitching, rivets, or adhesives, for example. Thus, any of the bottom members in the golf bag kit may be selected and connected to a complementary selected golf bag shell.

An embodiment of the golf bag bottom member 27 is shown in FIG. 7. The golf bag bottom member 27 comprises a bottom 29, a plurality of tab connectors 24b, and a side wall 28. The golf bag bottom member 27 may be connected to bottom collar 28 to form the bottom of the golf bag. The embodiment of the bottom collar 28 comprises bottom member slot connectors 24a; the bottom member slot connectors 24a on the bottom collar 28 are complementary connectors to the tab connectors 24b on the bottom member 27 and may form a permanent connection between the golf bag shell 10 and the bottom member 27.

Though not shown in FIG. 7, the bottom collar 28 would be connected to a golf bag enclosure. The embodiment of the bottom collar 28 also comprises a plurality of stay connectors 12a and a side wall 21. An inner diameter of at least a bottom portion of the side wall 21 of the bottom collar is slightly larger than the outer diameter of the side wall 28 of the bottom member 27 such that a portion of the bottom member 27 may be inserted into the bottom collar 28. The bottom member may then be held securely within the bottom collar.

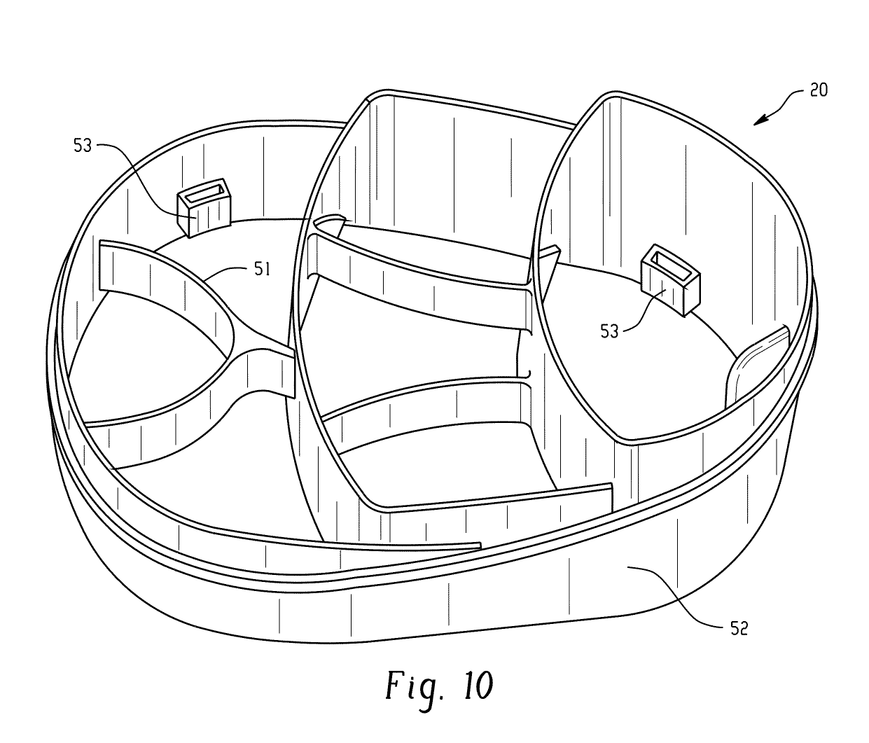

In some embodiments, the bottom collar 28 will comprise a flexible material such that the bottom collar 28 may be deformed to conform to the shape of the bottom member 27. An embodiment of the golf bag kit may comprise a plurality of bottom members including, for example, a round golf bag bottom 27 and substantially rectangular golf bag bottom 47 as shown in FIG. 9. Bottom collar 28 has an inner peripheral length that is substantially similar to the outer circumferential peripheral length of the side wall 28 of the bottom member 27 and the outer peripheral length of the side wall 48 of the bottom member 47 such that either of the bottom members 27 or 47 may be selectively connected to bottom collar 28. In such embodiments of the golf bag kit, the bottom collar 28 must be sufficiently flexible to conform to the peripheral shape of the side walls of either bottom member 27 or bottom member 47. Further, in certain embodiments comprising complementary connectors between the bottom member and the bottom collar, the tab connectors 24b and 44b are equally sized and spaced to match with at least a portion of the slot connectors 24a on the bottom collar 28 such that either bottom member 27 or bottom member 47 may be connected to the bottom collar 28 using the connectors. In other embodiments, the bottom collar may comprise a variety of different connectors capable of connecting to different bottom members of the kit or the bottom members and bottom collar may be connected by separate connectors as described above.

The bottom members may also have a profile on the side wall that is complementary to the profile on the bottom collar so they may fit together tightly.

Embodiments of the bottom members may further comprise feet, a connection for a stand system or other desired components, for example.

Top Members

In other embodiments, the golf bag kit may comprise a plurality of golf bag top members. The golf bag top members may be different from the other golf bag top members based on shape, color, weight, perimeter shape, number, pattern, and/or position of partitioning dividers, handles, cover attachment capabilities, stand system capabilities, accessory attachment capabilities, or other features. Some of the golf bag top members may comprise features that match one or more of the bottom members. In certain embodiments of the golf bag kit, each of the golf bag top members comprises at least one connector capable of being attached to any of the golf bag shells available in the golf bag kit. As with the bottom members, in other embodiments, the top members may not comprise a connector but may be attached to the golf bag shell by a separate connector such as, but not limited to, stitching, rivets, or adhesives, for example. Thus, any of the top members may be selected and connected to the selected golf bag shell.

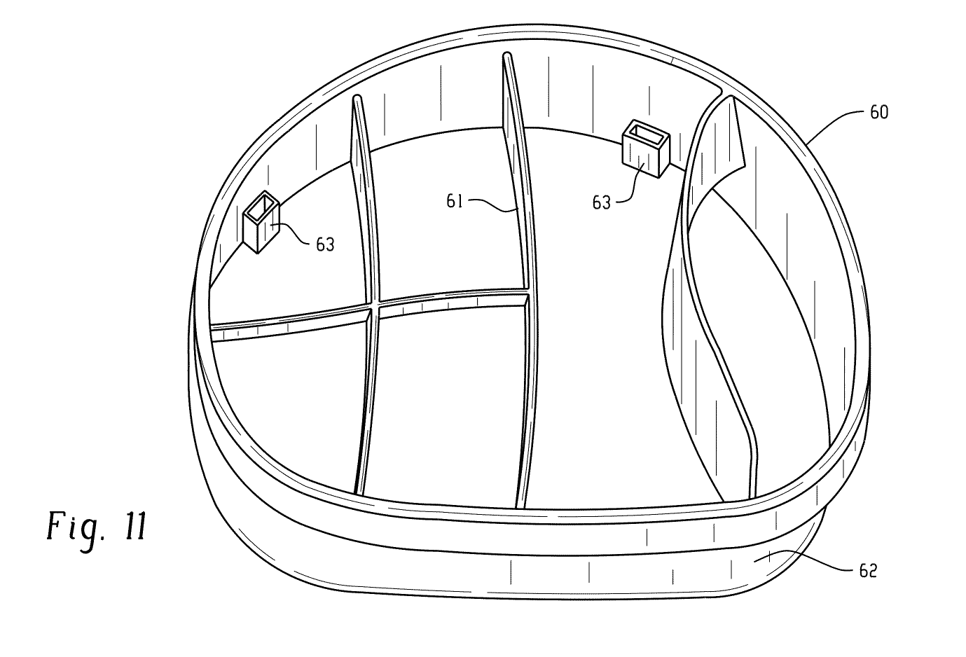

An embodiment of a top member is shown in FIG. 10. The top member 20 comprises a side wall 52 having an oval or egg shaped periphery, partitioning dividers 51, and slot connectors 53. The top member 20 may be one of the plurality of top members available in an embodiment of a golf bag kit. The top member 20 may be connected to a top collar 11 as shown on FIG. 6. The top collar 11 may have the same peripheral shape as the rigid side wall 52 of the top member 20 or the top collar 11 may be sufficiently flexible to be deformed to conform to the peripheral shape as the rigid side wall 52 of the top member 20 and the other peripheral shapes of additional top members of the golf bag kit.

An additional embodiment of a top member is shown in FIG. 11. The top member 60 comprises a side wall 62 having different shaped periphery and different shaped partitioning dividers 61 as the top member 20 in FIG. 10. However, may be part of the same golf bag kit if the top collar is sufficiently flexible, has a similar peripheral length, profile and/or location of connectors to independently be connected to each top member 20 or 60. These top members 20 and 60 may be two of the plurality of top members available in an embodiment of a golf bag kit.

Another embodiment of a top member 68 and golf bag shell sub-assembly 69 is shown in FIG. 11A. The golf bag shell sub-assembly 69 comprises a top collar 64 stitched to an enclosure 65. The top collar 64 has a curved profile on its top surface 64a. An embodiment of the top member 68 comprises a complementary profile to the top collar 64. Additionally, the top member 68 comprises an inner wall 67 and an outer wall 66 forming a recess between the inner wall 67 and outer wall 66. The top collar may be slid within the recess as shown in the cross-sectional view shown in FIG. 11B. The top member 68 comprises tab connectors 67A that may be inserted into slot connectors on the inside surface of the top collar 64. In some embodiments the golf bag kits comprises a plurality of top members that each has a recess profile that is complementary to the top surface profile of the top collar. In other embodiments, the bottom members of a golf bag kit may comprise a complementary profile to the bottom surface profile of the bottom collars.

In another embodiment of the golf bag kit, the top collar 11 may be rigid and have the same peripheral shape and profile as the rigid side wall 52 of the top member 20 and the rigid side wall 62 of the top member 60 and any other top members available in the kit.

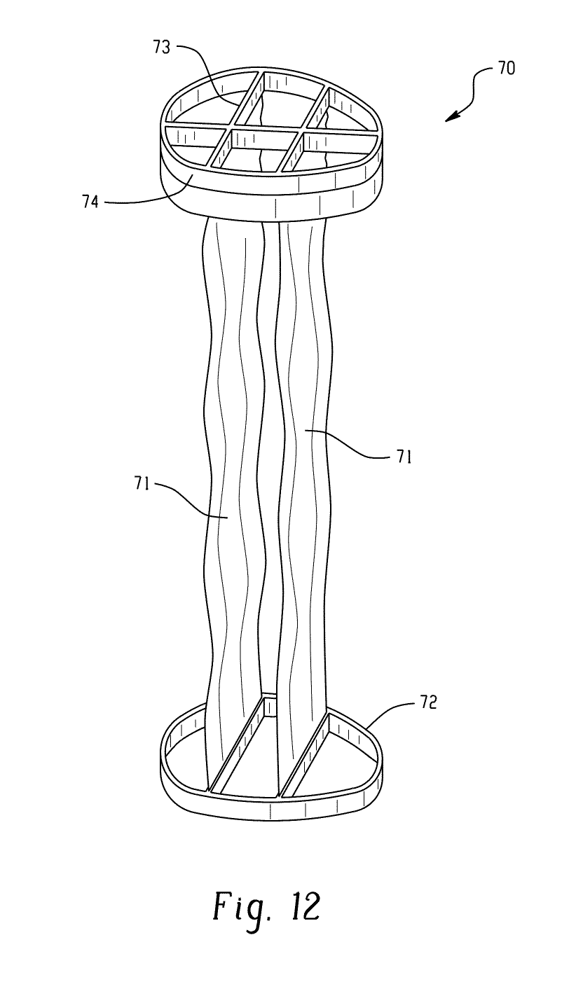

As shown in FIG. 12, the top member may be provided as a second sub-assembly. For example, an embodiment of the top member sub assembly may further comprise partitioning straps 71 connected to the partitioning dividers 73 of the top member 74. The partitioning straps 71 may further be connected to an intermediate member 72 at their other end. In such embodiments, the top member sub-assembly may be attached to both a top portion of the golf bag shell and a bottom portion of the golf bag shell. For example, as shown in FIG. 7, embodiments of the intermediate member 72 comprise at least one connector 23b capable of attaching to at least one of the bottom collar 28, the bottom member 27 or other connector on the golf bag shell. The intermediate member 72 may further comprise stay notches 26 that allow the intermediate member to be inserted in the golf bag shell and pulled through past the stays 14 for connection at the bottom of the golf bag shell. The stay notches may also help with alignment of the intermediate member 72 with the correct position to connect to the bottom collar 28.

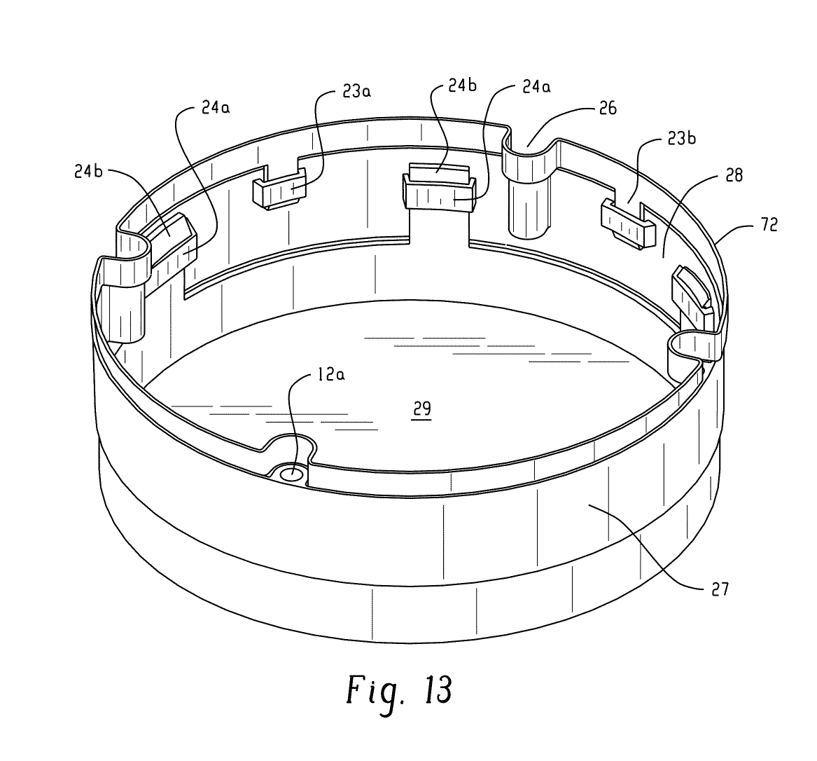

FIG. 13 depicts an embodiment of the bottom member 27, the bottom collar 28 and the intermediate member 72 connected together as in a completed golf bag. For clarity, an enclosure and partitioning straps are not shown in FIG. 13. In the embodiment shown, the partitioning straps are connected to the perimeter of the intermediate member 72 and the enclosure is connected to the bottom collar 28. The bottom collar 28 comprises slot connectors 23a to receive tab connectors 23b of the intermediate member 72 to permanently connect the intermediate member 72 to the bottom collar 28. Further, the bottom member 27 comprises tab connectors 24b that may be inserted into the slot connector 24a of the bottom collar 28. The bottom member 27, bottom collar 28 and intermediate member 72 form the bottom assembly to hold the partitioning straps 71 in position and form the bottom of the golf bag. The bottom 29 is now the bottom of the golf bag.

On embodiments of a carry bag kit, the top members may comprise a bracket 8 for rotatably connecting the legs 4 of a stand system 7 to the top member 20. The bracket 8 may be molded with the top member or manufactured separately and connected together.

The golf bag top member sub-assembly or a golf bag kit may comprise a flexible covering material as described in patent application entitled “Golf Bags, Golf Bag Top Members, and Golf Bag Top Member Coverings”.

Other Components

In other embodiments, the golf bag kits may comprise other components that may be selectively connected to the selected golf bag shell including but not limited to stand systems, handles, pockets and carrying straps. The legs of the stand system may be available in various configurations in embodiments of the golf bag kit and may comprise various feet, for example.

### PROPHETIC EXAMPLES

### Example 1

### Method of Selling a Cart Bag

An embodiment of the method of selling a cart golf bag kit may comprise manufacturing a plurality of golf bag shell sub-assemblies. The golf bag shell sub-assemblies will be available in nine different golf bag shell sub-assemblies styles and configurations, a plurality of bottom members available in six different bottom member styles and configurations, and a plurality of top member sub-assemblies available in six different top member sub-assembly styles and configurations. Each of the golf bag shell sub-assemblies comprise a flexible enclosure with a top opening and a bottom opening, a top collar attached adjacent to the top opening, a bottom collar attached adjacent to the bottom opening and stays connected between the top collar and the bottom collar.

The golf bag shells comprise three different configurations, an economical golf bag shell, an intermediate golf bag shell, and a high end golf bag shell. Each of the styles and configurations are available in three different colors. Each of the configurations of golf bag shells will comprise similarly shaped top collars and the top collars have connectors complementary to the connectors on each of the golf bag top members. The top collars will have substantially similar perimeters and profile of the top collars. The profile of the top collar includes the shape of the top portion of the top collar that engages the top member. The economical golf bag shell will comprise four separate pockets and an enclosure made from a durable 210D polyester/nylon construction. The economical golf bag shell is available in three primary colors, red, orange and black. Each of the colors has at least one additional accent color.

The intermediate golf bag shell will comprise eight separate pockets including fleece lined pockets and an insulated pocket and an enclosure made from a light weight and durable 420D tartan and dobby nylon material. The intermediate golf bag shell is available in three primary colors, blue, green and black. Each of the colors has at least one additional accent color also on the enclosure.

The high end golf bag shell will comprise fourteen separate pockets including a fleece lined pockets and an insulated pocket, an external putter tube and an enclosure made from a lightweight hexagon rip-stop nylon. The top end golf bag shell is available in three primary colors, navy, maroon, and black. Each of the colors has at least one additional accent color.

Any of the golf bag shells may be connected to any of the golf bag top member assemblies. The golf bag top assemblies will comprise a top member, partitioning straps and an intermediate member. The first top member will have four apertures for organizing clubs with two partitioning straps connected between the top member and the intermediate member. The second top member assembly will have eight apertures defined by the partitioning dividers and three partitioning straps connected between the top member and the intermediate member. The third top member assembly in the golf bag kit will have fourteen apertures, one for each club in a full set of clubs, defined by the partitioning dividers and four partitioning straps connected between the top member and the intermediate member. The third top member will additionally comprise a fabric partitioning divider and top member covering. Each of the top members will comprise permanent connectors complementary to connectors on the top collar of the three golf bag shells in the golf bag kit. Each configuration of the top member sub-assembly will be available in two different colors, black and grey.

The golf bag kit also comprises three bottom members, each of which can be connected to the bottom collar of each of the golf bag shells in the golf bag kit. The first bottom member comprises a substantially flat bottom without feet. The second bottom member comprises feet molded with the bottom member to provide a more stable platform to maintain the golf bag in a standing position. The third bottom member comprises non-slip rubber feet separately molded onto the bottom member. Each configuration of the bottom member will be available in two different colors, black and grey.

A consumer may select one golf bag shell sub-assembly, one top member sub-assembly and one bottom member. The selections are received by the seller of the golf bag, golf bag kit, or golf bag components. The seller will then aggregate the selected components. The aggregated components may then be assembled into a golf bag.

The embodiments of the golf bag, golf bag kit and method of producing a golf bag are not limited to the particular embodiments, components, method steps, and materials disclosed herein as such components, process steps, and materials may vary. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

1. A method of selling a golf bag, comprising:
providing at least one golf bag shell having at least one open end;
providing a plurality of bottom members or a plurality of top members, wherein each of the bottom members or each of the top members are capable of selectively being connected to each of the golf bag shells; and
receiving a selection of a selected golf bag shell from of the at least one golf bag shells; and
receiving the selection of a selected bottom member from the plurality of bottom members or a selected top member from the plurality of top members.

2. The method of claim 1, comprising:
providing a plurality of bottom members and a plurality of top members, wherein each of the bottom members and each of the top members are capable of selectively being connected to the golf bag shell; and
receiving a selection of a selected bottom member from the plurality of bottom members and a selected top member from the plurality of top members.

3. The method of claim 1, further comprising:
connecting the selected golf bag shell to the selected bottom member or selected top member.

4. The method of claim 1, further comprising:
instructing a third party to connect the selected golf bag shell to the selected bottom member or selected top member.

5. The method of claim 1, wherein the top member is a component of a top member sub-assembly, wherein the top member sub-assembly comprises the top member, at least one partitioning strap and an intermediate member.

6. The method of claim 5, wherein the top member is connected to one end of the partitioning strap and the intermediate member is connected to the other end of the partitioning strap.

7. The method of claim 6, wherein the golf bag shell is a component of a golf bag shell sub-assembly, wherein the golf bag shell sub-assembly comprises the golf bag shell, a top collar and a bottom collar.

8. The method of claim 7, wherein the golf bag shell sub-assembly further comprises at least one stay connected between the top collar and the bottom collar.

9. The method of claim 7, wherein the bottom member and the intermediate member comprise connectors capable of being attached to connectors on the bottom collar and the top member comprises connectors capable of connecting the top member to the top collar.

10. The method of claim 1, wherein the selection of a golf bag shell and the selection of a selected bottom member or a selected top member is received over a computer network.

11. The method of claim 10, wherein the computer network is at least one of a telephone network or internet.

12. The method of claim 11, wherein the selection of a golf bag shell and the selection of a selected bottom member or a selected top member is received at a retail store.

13. The method of claim 12, wherein the selected bottom member or selected top member is connected to the golf bag shell at the retail store.

14. The method of claim 13, wherein the selected golf bag shell, selected bottom member or selected top member are aggregated at the retail store.

15. A method of selling a golf bag, comprising:
receiving a selection by a consumer from a plurality of bottom members compatible with a golf bag shell; and
connecting the bottom member to the golf bag shell.

16. A method of selling a golf bag, comprising:
providing at least one golf bag shell having an open bottom member, wherein the open bottom end is defined by a bottom end collar and the bottom end collar comprises at least one bottom connector;
providing a plurality of bottom members, wherein each bottom member comprises a complementary connector capable of connecting the bottom member to the bottom connector;
receiving a selection of a selected bottom member from the plurality of bottom members; and
selling the golf bag shell and the selected bottom member to a third party.

17. The method of claim 16, comprising instructing the third party to connect the selected bottom member to the open bottom member to provide a golf bag.

18. The method of claim 16, comprising assembling the golf bag from the selected bottom and golf bag shell.

19. The method of claim 16, further comprising providing a plurality of top members wherein each of the top members is capable of being permanently connected to each of the golf bag shells; and receiving a selection of a selected top member from the plurality of the top members.

20. A method of selling a golf bag, comprising:
receiving a selection by a consumer from a plurality of bottom members compatible with a golf bag shell; and
instructing the consumer to connect the bottom member to the golf bag shell.
